(19) United States
(12) Patent Application Publication
(10) Pub. No.: US 2025/0069109 A1
(43) Pub. Date: Feb. 27, 2025

(54) Ecosystem Analysis Method and Ecosystem Analysis System

(71) Applicant: Hitachi, Ltd., Chiyoda-ku, Tokyo (JP)

(72) Inventor: Kentarou WATANABE, Tokyo (JP)

(21) Appl. No.: 18/719,329

(22) PCT Filed: Dec. 1, 2022
(86) PCT No.: PCT/JP2022/044437

§ 371 Date: Jun. 13, 2024

(30) Foreign Application Priority Data
Dec. 14, 2021 (JP) 2021-202581

(51) Int. Cl. G06Q 30/0207; G06Q 30/0226; G07C 13/00

(52) U.S. Cl. CPC G06Q 30/0224; G06Q 30/0231; G06Q 2230/00; G07C 13/00

(57) ABSTRACT

An ecosystem analysis method in which a plurality of users participate and service is provided among the users via a token, includes: obtaining a token transaction history expressing a transaction history of the token of the user and a user activity history expressing an activity history in the ecosystem of the user by a computer; calculating a loyalty index expressing a loyalty level of the user for the ecosystem on the basis of the token transaction history and the user activity history by the computer; and estimating loyalty level in the entire ecosystem by adding up the loyalty indexes of the plurality of users participating in the ecosystem.

### TECHNICAL FIELD

The present invention relates to a method and a system for analyzing an ecosystem in which service is provided to a user via a digital token.

### BACKGROUND ART

In recent years, the use of a technique of forming an economic bloc (token economy) of an ecosystem mainly using tokens in place of currency by electronically issuing a unique digital token (hereinafter, simply called “token”), managing it user by user, and providing various services among users via the tokens is growing. To enlarge such token economy and realize sustainable operation, loyalty for attracting various users participating in an ecosystem not only a service provider (servicer) providing service but also a service user (consumer) using the service, a service intermediator (distributor) mediating provision and use of the service, and the like to the ecosystem is important. Based on such a background, a service activating method for increasing loyalty of each of users to an ecosystem is attracting attention in recent years.

As a conventional technique related to loyalty, the technique of Patent Literature 1 is known. Patent Literature 1 discloses a technique of analyzing loyalty by using an RFM analysis as one of customer analysis methods by marketing. The RFM analysis is an analysis method targeting maximization of LTV (lifetime value of customers) by grouping customers on the basis of three indexes of “Recency”, “Frequency”, and “Monetary” and executing a marketing policy adapted to the characteristics of each group. In grouping by recency, when a customer purchased a product most recently is extracted from “purchase date and time” in purchase data of customers, and the customers are grouped based on the timings. In grouping by frequency, customers are grouped based on purchase frequencies. It is based on a hypothesis that the higher the purchase frequency of a customer is, the more the customer is a good one. In grouping by monetary, customers are grouped by total amount of purchase prices calculated from purchase history. It is based on a hypothesis that the larger the total amount of a customer is, the more the customer is a good one.

### CITATION LIST

### Patent Literature

Patent Literature 1: Japanese Unexamined Patent Application Publication No. 2012-247860

### SUMMARY OF INVENTION

### Technical Problem

For enlargement and long-period maintaining operation of a token economy, it is necessary to maintain relations with users. For the purpose, it is important to properly analyze an ecosystem in which a token economy is developed and, on the basis of the analysis result, continuously improve the operation conditions of a token so that the operation of the token is performed under convincing conditions which are easily used by users. In conventional model determining/selecting means like Patent Literature 1, however, although loyalty of a user from the servicer viewpoint can be estimated from the economical contribution degree such as service use history of a consumer, loyalty which is not reflected in the economical contribution degree such as the degree of attachment to an ecosystem of the user cannot be estimated. There is, consequently, a problem that it is difficult to properly analyze an ecosystem.

### Solution to Problem

An ecosystem analysis method according to the present invention is an ecosystem analysis method in which a plurality of users participate and service is provided among the users via a token, obtaining a token transaction history expressing the transaction history of the token of the user and a user activity history expressing an activity history in the ecosystem of the user by a computer, calculating a loyalty index expressing loyalty level of the user to the ecosystem on the basis of the token transaction history and the user activity history by the computer, and estimating loyalty level in the entire ecosystem by adding up the loyal indexes of a plurality of users participating in the ecosystem.

An ecosystem analysis system according to the present invention is a system for analyzing an ecosystem in which a plurality of users participate and service is provided via a token among the users, including: a storage unit storing a token transaction history table in which a token transaction history of each user is recorded, and a user activity history table in which an activity history in the ecosystem of each user is recorded; a user loyalty calculation unit calculating a loyalty index expressing loyalty level of each of users to the ecosystem on the basis of the token transaction history table and the user activity history table; and an ecosystem loyalty calculation unit estimating loyalty level of the entire ecosystem by adding up the loyalty indexes of the plurality of users participating in the ecosystem calculated by the user loyalty calculation unit.

### Advantageous Effects of Invention

According to the present invention, analysis of an ecosystem can be properly performed.

### BRIEF DESCRIPTION OF DRAWINGS

FIG. 1 is a block diagram illustrating a schematic configuration of a data management system according to an embodiment of the present invention.

FIG. 2 is a hardware configuration diagram of the data management system according to the embodiment of the present invention.

FIG. 3 is a diagram illustrating an example of the data structure of a token table.

FIG. 4 is a diagram illustrating an example of the data structure of a token model.

FIG. 5 is a diagram illustrating an example of the data structure of a token transaction history table.

FIG. 6 is a diagram illustrating an example of the data structure of a user activity history table.

FIG. 7 is a diagram illustrating an example of the data structure of a use case classification table.

FIG. 8 is a diagram illustrating an example of the data structure of an ecosystem maturation degree table.

FIG. 9 is a diagram illustrating an example of the data structure of a user role classification table.

FIG. 10 is a diagram illustrating an example of the data structure of a token holding time threshold table.

FIG. 11 is a diagram illustrating an example of the data structure of a model candidate table.

FIG. 12 is a diagram illustrating an example of the data structure of a model selection condition table.

FIG. 13 is a flowchart illustrating the flow of general process of a data management system at the time of updating a token model.

FIG. 14 is a flowchart illustrating the flow of loyalty level calculating/outputting process.

FIG. 15 is a flowchart illustrating the flow of psychological loyalty index calculating process.

FIG. 16 is a flowchart illustrating the flow of model change necessity determining process.

FIG. 17 is a diagram illustrating an example of an administration screen.

FIG. 18 is a diagram illustrating an example of a user screen.

### DESCRIPTION OF EMBODIMENTS

Hereinafter, embodiments of the present invention will be described with reference to the drawings. The present invention is not limited by the following embodiments, and all of components and combinations of them described in the embodiments are not always necessary to the solving means of the invention.

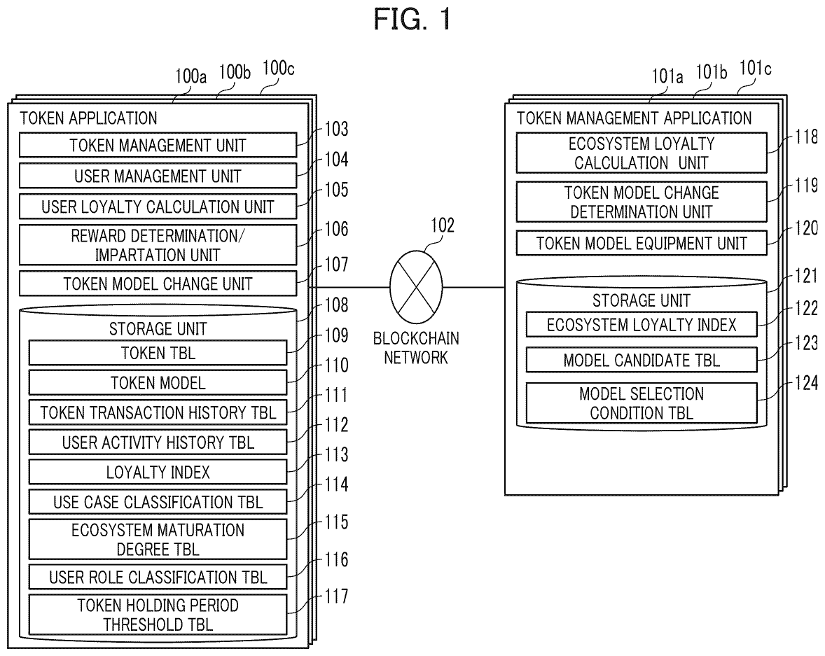

FIG. 1 is a block diagram illustrating a schematic configuration of a data management system according to an embodiment of the present invention. The data management system illustrated in FIG. 1 is an information processing system managing and operating tokens transmitted/received as consideration related to activities in an ecosystem among various users such as a servicer as a service provider, a consumer as a service user, and a distributor as a service intermediator for various services provided in the ecosystem, analyzing the ecosystem as necessary, and reexamining operation conditions of the tokens. In such a manner, in the data management system of the embodiment, the token operation conditions are continuously improved so that the operation of tokens is performed under conditions easily used and convincing for each of the users.

The data management system of the embodiment is, for example, an information system realized by using the blockchain technique and is configured, for example, as illustrated in FIG. 1, by mutually connecting token applications 100a, 100b, and 100c and token management applications 101a, 101b, and 101c via a blockchain network 102. The token applications 100a, 100b, and 100c and the token management applications 101a, 101b, and 101c are applications used by respective users when they are executed in information terminals such as a smartphone, a PC (personal computer), and the like of the users participating in the ecosystem. That is, by combining a plurality of user terminals executing the applications, the data management system of the embodiment is configured. In the following description, the token applications 100a, 100b, and 100c will be collectively called “token application 100”, and the token management applications 101a, 101b, and 101c will be collectively called “token management application 101”.

FIG. 1 illustrates an example of configuring the data management system of the embodiment by combining the three token applications 100 and the three token management applications 101. However, each of the number of the token applications 100 and the number of the token management applications 101 constructing the data management system of the embodiment is not limited to three. The data management system of the embodiment can be configured by combining arbitrary number of token applications 100 and arbitrary number of the token management applications 101 in accordance with the number of users participating in the ecosystem.

In the token application 100, a token is operated in accordance with a specified token model. The token application 100 measures the activity of the user and calculates the loyalty index of each of users, which will be described later.

The token application 100 has a token management unit 103, a user management unit 104, a user loyalty calculation unit 105, a reward determination/impartation unit 106, a token model change unit 107, and a storage unit 108. FIG. 1 illustrates the configuration of the token application 100a. Each of the token applications 100b and 100c also has a similar configuration. Hereinafter, the token application 100 will be described using the token application 100a as an example. In the description, unless otherwise mentioned, a “user” refers to a user participating in an ecosystem by using the token application 100a.

The token management unit 103 is a process unit managing all of tokens which are transmitted/received on the blockchain network 102 in the ecosystem in which the user participates.

The user management unit 104 is a process unit managing tokens which are currently held by the user and activities of the user in the ecosystem.

The user loyalty calculation unit 105 is a process unit calculating loyalty of the user. The loyalty of the user calculated is an index expressing psychological attachment of the user to the ecosystem, and is determined on the basis of a token transaction history and an activity history of the user in the ecosystem. A method of calculating the loyalty of the user by the user loyalty calculation unit 105 will be described later.

The reward determination/impartation unit 106 is a process unit determining the content of a reward to the user in accordance with reward conditions previously defined by a token model 110 which will be described later and imparting the reward according to the determined content to the user, thereby operating tokens in accordance with the token model 110.

The token model change unit 107 is a process unit changing the token operation condition by changing the token model 110 which will be described later to a new token model.

The storage unit 108 stores information related to the process units in the token application 100. The storage unit 108 stores various information including a token table 109, the token model 110, a token transaction history table 111, a user activity history table 112, a loyalty index 113, a use case classification table 114, an ecosystem maturation degree table 115, a user role classification table 116, and a token holding period threshold table 117.

The token table 109 expresses information of tokens currently held by the user, and the content is referred to and updated by the user management unit 104.

The token model 110 expresses a token model currently used by the token application 100, and its content is referred to by the reward determination/impartation unit 106 and the token model change unit 107 and is updated by the token model change unit 107. The token model is information expressing the operation mode of the token in the form of a model. The operation condition of the token in the ecosystem is determined by the token model. In the storage unit 108, information of a token model currently used among various token models which can be used by the data management system of the embodiment is recorded as the token model 110.

The token transaction history table 111 is information which is the token transaction history recorded with respect to each of all of users participated in the ecosystem, and its content is referred to and updated by the token management unit 103.

The user activity history table 112 is information which is the activity history in the ecosystem recorded with respect to each of all of the users participating in the ecosystem, and its content is referred to and updated by the user management unit 104. The user activity history recorded in the user activity history table 112 includes at least an activity history which does not accompany a transaction of a token among activity histories related to tokens held by each of the users. An activity history of a user accompanying a transaction of a token may be recorded as a token transaction history in the token transaction history table 111 or the user activity history table 112.

The loyalty index 113 is information of user loyalty expressing the degree of the psychological attachment of the user to the ecosystem, and is calculated by the user loyalty calculation unit 105.

The use case classification table 114 is information expressing a classification policy of a use case of the ecosystem and is preliminarily stored in the storage unit 108. At the time of calculating the loyalty index 113, the user loyalty calculation unit 105 specifies a use case classification of the ecosystem with reference to the use case classification table 114.

The ecosystem maturation degree table 115 is information expressing a policy of determining the maturation degree of the ecosystem, and is preliminarily stored in the storage unit 108. At the time of calculating the loyalty index 113, the user loyalty calculation unit 105 specifies the maturation degree of the ecosystem with reference to the ecosystem maturation degree table 115.

The user role classification table 116 is information expressing a policy of determining a role classification of each of users participating in the ecosystem, and is preliminarily stored in the storage unit 108. At the time of calculating the loyalty index 113, the user loyalty calculation unit 105 specifies a user role classification with reference to the user role classification table 116.

The token holding period threshold table 117 is information expressing a threshold to be compared with a holding period of a token held by the user, and is preliminarily stored in the storage unit 108. At the time of calculating the loyalty index 113, the user loyalty calculation unit 105 determines a threshold with reference to the token holding period threshold table 117 and compares the token holding period of the user and the threshold. By estimating the degree of psychological attachment of the user to the ecosystem on the basis of the comparison result, the loyalty index 113 is calculated.

The token management application 101 is an application for managing a token model used in operation of a token of each of users in the ecosystem. The token management application 101 calculates the loyalty index of the entire ecosystem by totaling the loyalty indexes calculated user by user by the token application 100, and determines whether change of the token model is necessary or not on the basis of the calculated loyalty index. In the case where it is determined as a result that the token model has to be changed, change to a token model according to the loyalty index of the ecosystem is instructed to the token application 100.

The token management application 101 has an ecosystem loyalty calculation unit 118, a token model change determination unit 119, a token model equipment unit 120, and a storage unit 121. FIG. 1 illustrates the configuration of the token management application 101a. Each of the token management applications 101b and 101c also has a similar configuration. Hereinafter, the token management application 101 will be described using the token management application 101a as an example.

The ecosystem loyalty calculation unit 118 is a process unit calculating loyalty of the entire ecosystem. The ecosystem loyalty calculation unit 118 calculates the ecosystem loyalty by collecting loyalty indexes of all of the users belonging to the ecosystem from the token applications 100 of the users and totaling them. In such a manner, the level of loyalty in the entire ecosystem can be estimated.

The token model change determining unit 119 is a process unit selecting another token model different from the current token model as a change candidate model from token models which can be used in the ecosystem, and determining whether a token model change to the change candidate model is executed or not. Whether a token model change is executed or not may be unilaterally determined by an administrator of the ecosystem or a servicer providing service or may be consensually determined by a servicer and a consumer. In the embodiment, an example of the case of consensually determining whether a token model is to be changed or not by users will be described later.

The token model equipment unit 120 is a process unit of equipping the token application 100 with a change candidate model as a token model after the change in the case where the token model change determination unit 119 determines to change the token model. The token model after the change equipped to the token application 100 in each user is applied by the token model change unit 107.

The storage unit 121 stores information related to each of the above-described process units in the token management application 101. In the storage unit 121, various information including an ecosystem loyalty index 122, a model candidate table 123, and a model selection condition table 124 is stored.

The ecosystem loyalty index 122 is information of ecosystem loyalty expressing the level of loyalty in the entire ecosystem, and is calculated by the ecosystem loyalty calculation unit 118.

The model candidate table 123 is information of a token model which can be used in the ecosystem and is preliminarily stored in the storage unit 121. At the time of proposing a change of the token model, the token model change determination unit 119 refers to the model candidate table 123 and selects a token model in the table as a change candidate model.

The model selection condition table 124 is information expressing a policy of selecting a change candidate model and is preliminarily stored in the storage unit 121. At the time of proposing a change of the token model, the token model change determination unit 119 selects a change candidate model with reference to the model selection condition table 124.

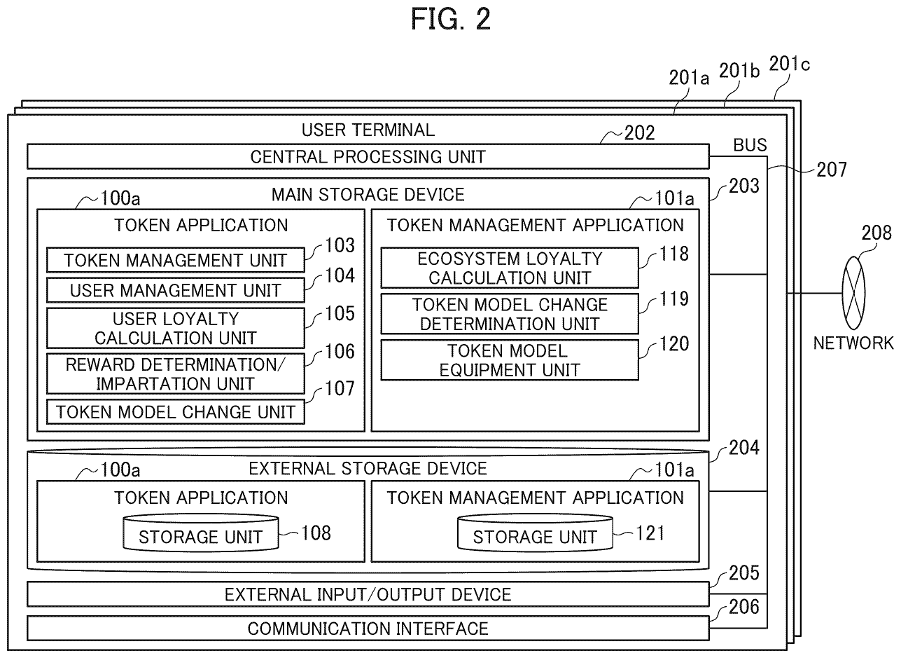

FIG. 2 is a hardware configuration diagram of a data management system according to an embodiment of the present invention. In the data management system of the embodiment, for example, as illustrated in FIG. 2, user terminals 201a, 201b, and 201c are mutually connected via a network 208. In the user terminals 201a, 201b, and 201c, the token applications 100a, 100b, and 100c and the token management applications 101a, 101b, and 101c described in FIG. 1 operate, respectively. It realizes the data management system of the embodiment illustrated in FIG. 1. In the following description, the user terminals 201a, 201b, and 201c will be collectively called a “user terminal 201”.

Although FIG. 2 illustrates an example that the data management system of the embodiment is configured by combining the three user terminals 201, the number of user terminals 201 constructing the data management system of the embodiment is not limited to three. The data management system of the embodiment can be configured by combining arbitrary number of user terminals 201 in accordance with the number of users participating in the ecosystem.

The user terminal 201 has a central processing unit 202, a main storage device 203, an external storage device 204, an external input/output device 205, and a communication interface 206 which are mutually connected via a bus 207. FIG. 2 illustrates the configuration of the user terminal 201a. Each of the user terminals 201b and 201c also has a similar configuration. Hereinafter, the user terminal 201 will be described using the user terminal 201a as an example.

The main storage device 203 is a memory used as a work area when the central processing unit 202 executes various programs. In the main storage device 203, the above-described process units (the token management unit 103, the user management unit 104, the user loyalty calculation unit 105, the reward determination/impartation unit 106, and the token model change unit 107) belonging to the token application 100a are mounted. When a program stored in the external storage device 204 is developed into the main storage device 203 and executed by the central processing unit 202, the process units are realized in the user terminal 201a.

In the main storage device 203, the above-described process units (the ecosystem loyalty calculation unit 118, the token model change determination unit 119, and the token model equipment unit 120) belonging to the token management application 101a are also mounted. Those process units are also realized in the user terminal 201a when the program stored in the external storage device 204 is developed in the main storage device 203 and executed by the central processing unit 202.

The external storage device 204 is a nonvolatile recording medium storing various programs executed by the central processing unit 202 and various information used by the programs executed by the central processing unit 202 and is configured by, for example, a recording medium such as an HDD (Hard Disk Drive) or an SSD (Solid State Drive). The external storage device 204 functions as the storage unit 108 of the token application 100a and the storage unit 121 of the token management application 101a, and records the above-described information stored in those storage units.

The external input/output device 205 is a device receiving various input operations from the user using the user terminal 201 and providing various information to the user, and is configured by using, for example, a display device, a keyboard, a touch panel, and the like. The content of an input operation from the user received by the external input/output device 205 is output to the central processing unit 202 and is reflected in a process executed by the central processing unit 202. The content of information provided to the user by the external input/output device 205 is controlled by the central processing unit 202.

The communication interface 206 performs a communication interface process so that various information is transmitted/received among the user terminals 201 via the network 208. The network 208 is, for example, the internet or the like and corresponds to the blockchain network 102 in FIG. 1. The network 208 may be either a wireless network or a wired network or may be configured by a combination of a wireless network and a wired network.

Although the example of using the blockchain technique in the data management system of the embodiment is described, the blockchain technique may not be used. In such a case, a configuration may be also employed in which the plurality of user terminals 201 executing the token applications 100 and a management server executing the token management application 101 are connected mutually via the network 208.

Although FIG. 2 illustrates the example that both the token application 100a and the token management application 101a operate on the same user terminal 201a, either one of them may operate. It is similar also with respect to the user terminals 201b and 201c. That is, the token application 100 and the token management application 101 do not always have to be executed on the same user terminal but may be executed on different user terminals.

Subsequently, the details of information stored in the storage units 108 and 121 will be described.

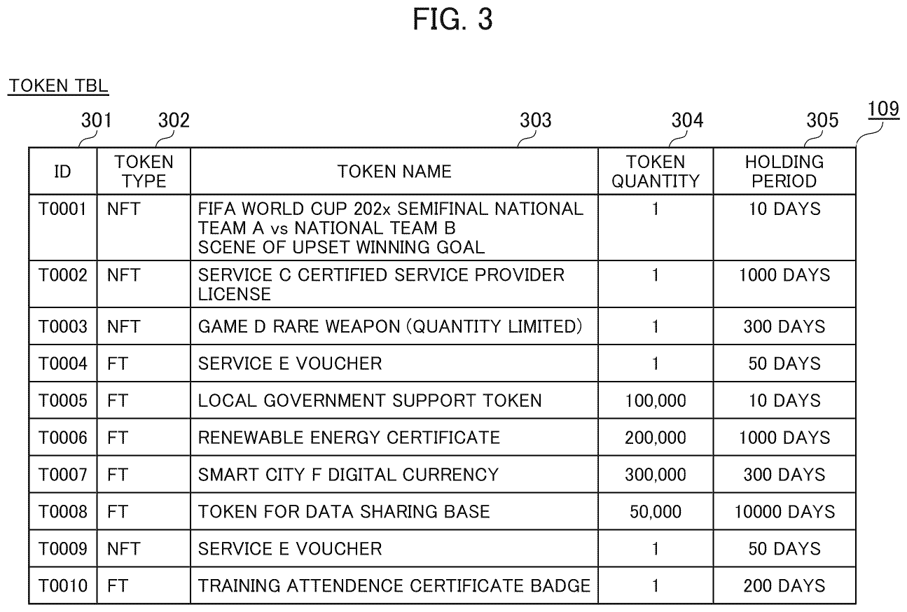

FIG. 3 is a diagram illustrating an example of the data structure of the token table 109. A record in the token table 109 is set for each of tokens held by the user. Consequently, a list of tokens held by the user in the data management system of the embodiment is recorded in the token table 109. The token table 109 illustrated in FIG. 3 has an ID column 301, a token type column 302, a token name column 303, a token quantity column 304, and a holding period column 305.

In the ID column 301, an identifier for uniquely identifying each of tokens used in the ecosystem is stored. As long as each token can be uniquely identified in the ecosystem, the identifier in the ID column 301 may have any expression method such as a URL expression method.

In the token type column 302, the type of a token is stored. For example, “FT” is recorded in the case of a fungible token and “NFT” is recorded in the case of a non-fungible token as the type of the token.

In the token name column 303, the name of the token is stored.

In the token quantity column 304, the quantity of the tokens is stored. For example, in the case of countable tokens whose token type recorded in the token type column 302 is “FT”, the number expressing the quantity of tokens is recorded in the token quantity column 304. On the other hand, in the case of uncountable tokens whose token type recorded in the token type column 302 is “NFT”, “1” is recorded in the token quantity column 304. Even in the case where the token type is “NFT”, with respect to tokens which can be grouped according to a predetermined criterion or a pattern, a record in the token table 109 may be allocated to the grouped tokens, and the number of tokens belonging to the group may be recorded in the token quantity column 304.

In the holding period column 305, an elapse period since the user obtains a token is stored. It is sufficient to store information indicating a period in which the user actually holds the tokens since the user obtained the token. The unit may be the number of days, year, hour, minute, second, or the like.

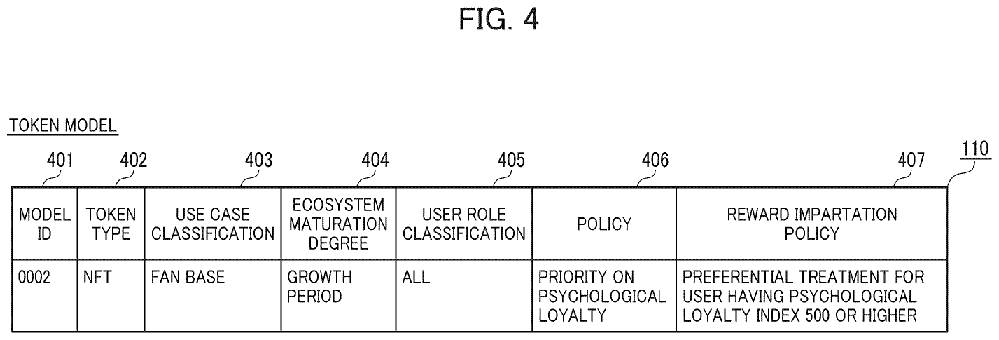

FIG. 4 is a diagram illustrating an example of the data structure of the token model 110. A record in the token model 110 is set in correspondence with the token model currently selected in the ecosystem in which the user participates. The token model 110 illustrated in FIG. 4 includes a model ID column 401, a token type column 402, a use case classification column 403, an ecosystem maturation degree column 404, a user role classification column 405, a policy column 406, and a reward imparting policy column 407.

In the model ID column 401, an identifier for uniquely identifying the token model which is currently selected is stored.

In the token type column 402, the type of the token related to the token model being selected is stored. In this column, information similar to that in the token type column 302 in the token table 109 in FIG. 3 is stored. Specifically, in the case of a fungible token, “FT” is recorded and in the case of a non-fungible token, “NFT” is recorded as the type of the token whose operation condition is determined according to the token model being selected.

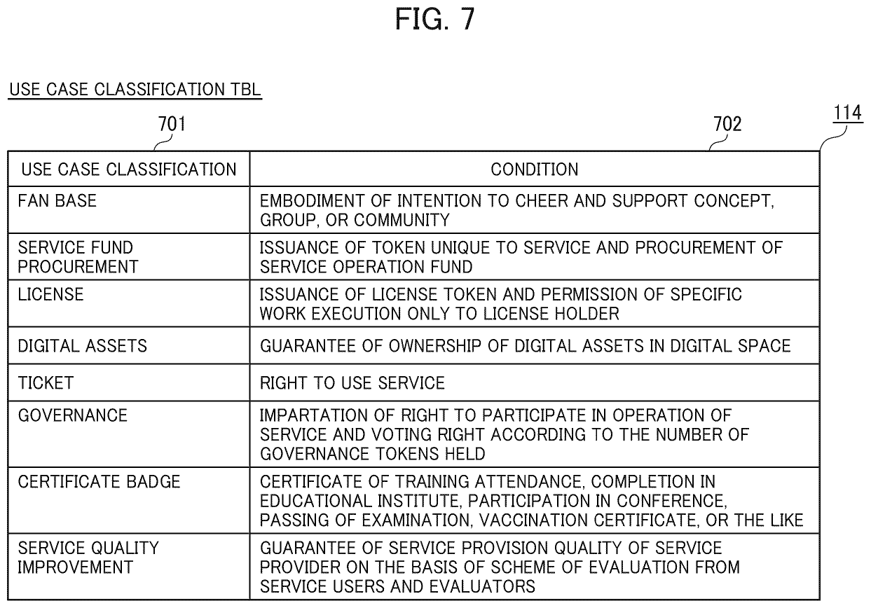

In the use case classification column 403, the classification of the use case of the ecosystem in which the token model being selected is used is stored. The classification of the use case recorded here is defined by the use case classification table 114 of FIG. 7 which will be described later.

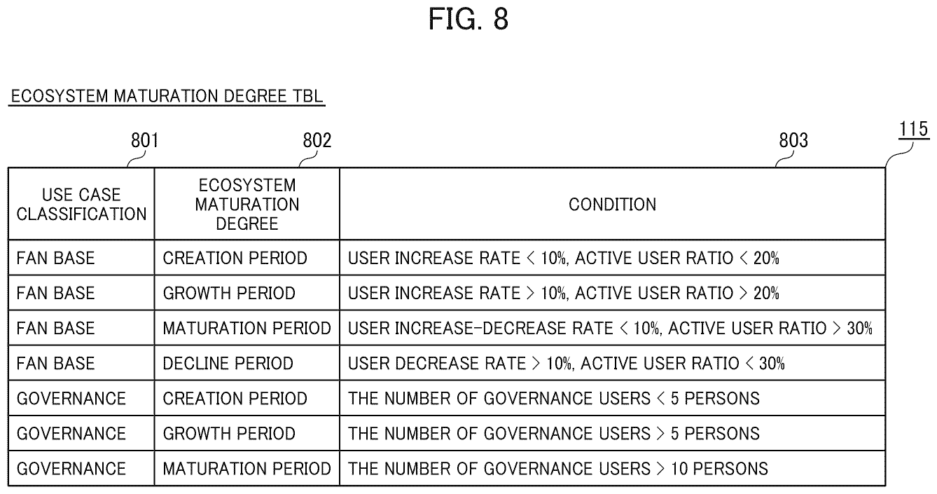

In the ecosystem maturation degree column 404, the maturation degree of the ecosystem in which the token model being selected is used is stored. The degree of maturation of the ecosystem recorded here is defined by the ecosystem maturation degree table 115 of FIG. 8 which will be described later.

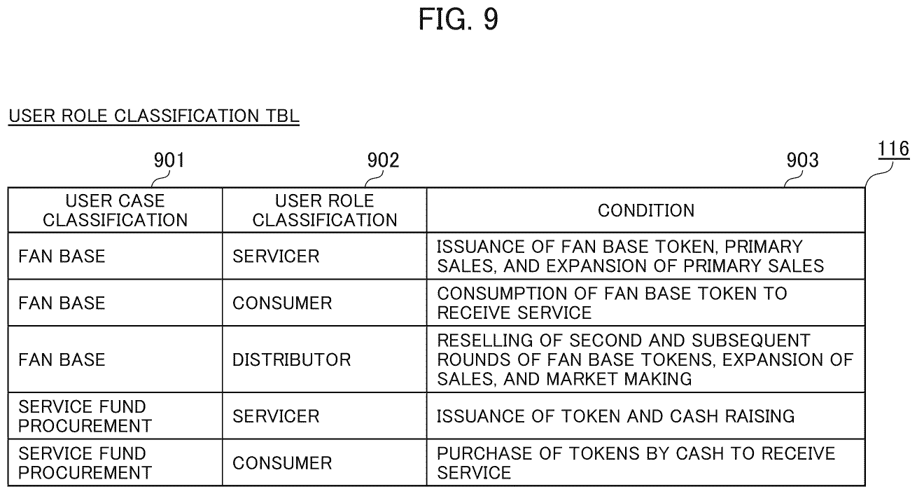

In the user role classification column 405, the role classification of the user assumed by the token model being selected is stored. The role classification of the user recorded here is defined by the user role classification table 116 of FIG. 9 which will be described later.

In the policy column 406, a priority policy related to loyalty of the token model being selected is stored. For example, in the case of a token model prioritizing economic loyalty using direct contribution to the economic activity of the servicer as an index, “economic loyalty priority” is recorded in the policy column 406. On the other hand, in the case of a token model prioritizing the psychological loyalty as an index of the degree of attraction of the user to a psychological ecosystem to indirectly contribute to the economic activity of a servicer for example, “psychological loyalty priority” is recorded in the policy column 406.

In the reward imparting policy column 407, a reward impartation condition and reward impartation means to the user of the token model being selected are stored. In the ecosystem using the token model, when the user commits an action satisfying the condition described in the reward imparting policy column 407, the reward described here is paid to the user. Such impartation of a reward is executed automatically by a program and may be realized by, for example, smart contract.

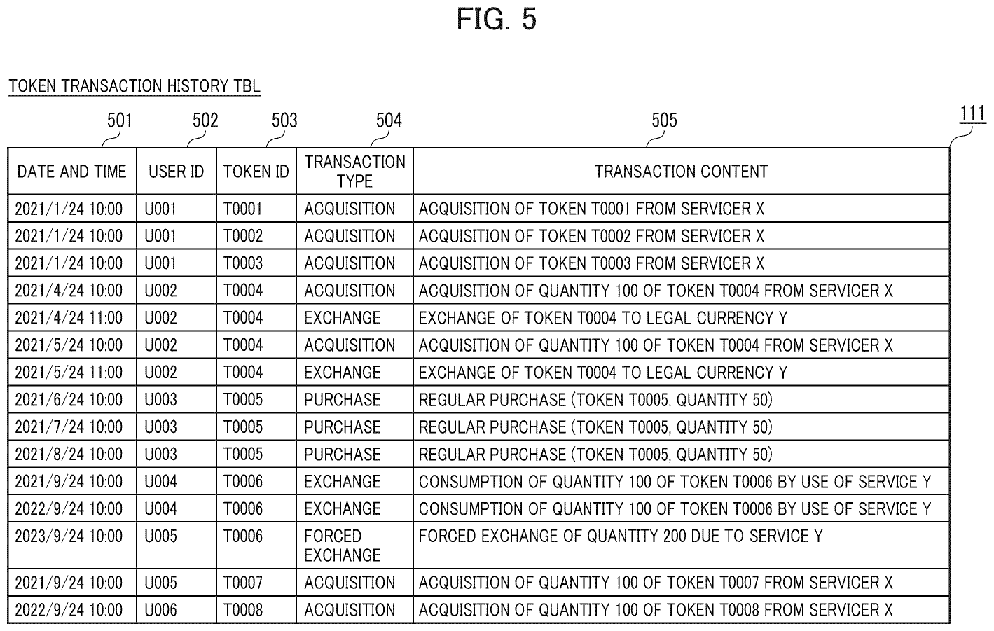

FIG. 5 is a diagram illustrating an example of the data structure of the token transaction history table 111. A record in the token transaction history table 111 is set for each of token transaction actions conducted by all of the users participating in the ecosystem, in the ecosystem realized on the blockchain network 102 by the data management system of the embodiment. Consequently, token transaction histories of all of the users in the data management system of the embodiment are recorded as content common to the user terminals 201 as the token transaction history table 111. The token transaction history table 111 illustrated in FIG. 5 has a date and time column 501, a user ID column 502, a token ID column 503, a transaction type column 504, and a transaction content column 505.

In the date and time column 501, date and time when the user executes a token transaction action are stored.

In the user ID column 502, an identifier for uniquely identifying the user who executed the token transaction action is stored.

In the token ID column 503, an identifier for uniquely identifying the token as a transaction object is stored. Identification information corresponding to that stored in the ID column 301 in the token table 109 of FIG. 3 is stored here.

In the transaction type column 504, the type of the token transaction action is stored. In this column, the content is recorded, for example, as “acquisition” in the case where the user executes a transaction action of acquiring a token, “exchange” in the case where the user executes a transaction action of exchanging a token to currency, another service, or the like, “purchase” in the case where the user executes a transaction action of purchasing a token, “forced exchange” in the case where a token is forcedly exchanged to another service or the like regardless of the intension of the user, and the like.

In the transaction content column 505, concrete content of the token transaction action is stored.

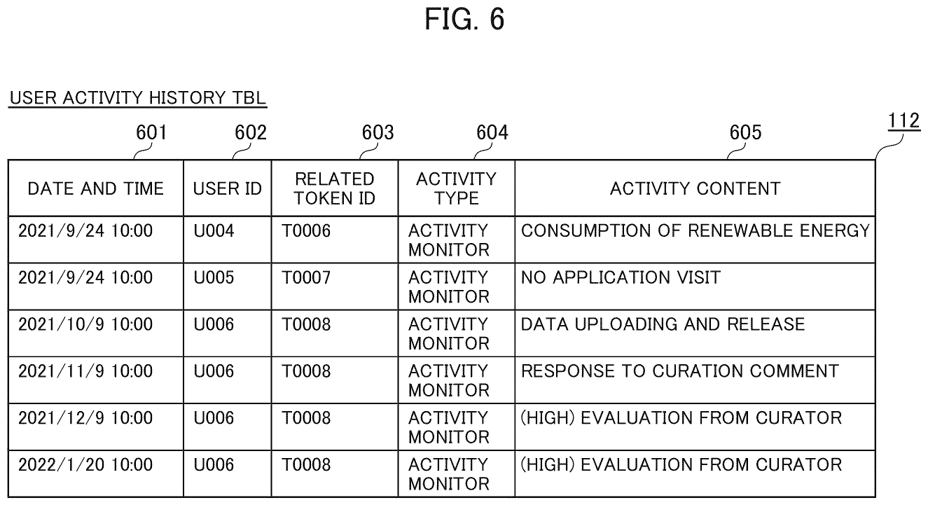

FIG. 6 is a diagram illustrating an example of the data structure of the user activity history table 112. A record in the user activity history table 112 is set for each of actions conducted by all of the users participated in an ecosystem realized on the blockchain network 102 by the data management system of the embodiment. Consequently, action histories in the ecosystem of all of the users in the data management system of the embodiment are recorded as content common to the user terminals 201 as the user activity history table 112. The user activity history table 112 illustrated in FIG. 6 has a date and time column 601, a user ID column 602, a related-token ID column 603, an activity type column 604, and an activity content column 605.

In the date and time column 601, date and time when a user makes any action to be recorded in the ecosystem are stored.

In the user ID column 602, an identifier for uniquely identifying the user who made the activity is stored. Identification information corresponding to that stored in the user ID column 502 in the token transaction history table 111 of FIG. 5 is stored here.

In the related-token ID column 603, an identifier for uniquely identifying a token related to the activity made by the user is stored. The identifier of a token which is assumed to have the highest degree of relation to the activity content among tokens held by the user who made the activity is recorded. For example, in the case where the number of types of tokens operated in the ecosystem in which the user made the activity is one, the identifier of the token is recorded in the related-token ID column 603. Like in the token ID column 503 in the token transaction history table 111 of FIG. 5, identification information corresponding to that stored in the ID column 301 in the token table 109 of FIG. 3 is stored in the related-token ID column 603.

In the activity type column 604, the type of the activity made by the user is stored. For example, in the case where the user executes an activity which does not accompany increase/decrease of tokens held by the user in the ecosystem, the content such as “activity monitor” is recorded in the activity type column 604.

In the activity content column 605, concrete content of the activity made by the user is stored.

The data management system of the embodiment may have a configuration which is not realized by using the blockchain technique as described above but in which a plurality of user terminals 201 executing the token applications 100 respectively and a management server executing the token management application 101 are mutually connected via the network 208. In this case, in each of the user terminals 201, it is preferable to record only a token transaction history and an activity history of the user who holds the user terminal 201 in the token transaction history table 111 and the user activity history table 112. On the other hand, in the management server, it is preferable to collect a token transaction history and an activity history of each user from each user terminal 201 and record token transaction histories and activity histories of all of users as the content illustrated in FIGS. 5. and 6.

FIG. 7 is a diagram illustrating an example of the data structure of the use case classification table 114. A record in the use case classification table 114 is set for each of classifications (categories) of use cases defined for the ecosystem. In such a manner, a classification policy of use cases of the ecosystem is expressed. The use case classification table 114 illustrated in FIG. 7 has a use case classification column 701 and a condition column 702.

In the use case classification column 701, classifications of defined use cases are stored.

In the condition column 702, a condition satisfying a classification described in the use case classification column 701 is stored.

FIG. 8 is a diagram illustrating an example of the data structure of the ecosystem maturation degree table 115. A record in the ecosystem maturation degree table 115 is set for each combination between a classification of a use case defined for the ecosystem and the maturation degree. In such a manner, a policy of determining the maturation degree of the ecosystem is expressed. The ecosystem maturation degree table 115 illustrated in FIG. 8 has a use case classification column 801, an ecosystem maturation degree column 802, and a condition column 803.

In the use case classification column 801, a classification of a defined use case is stored. In this column, information corresponding to that stored in the use case classification column 701 in the use case classification table 114 of FIG. 7 is stored.

In the ecosystem maturation degree column 802, a classification of the maturation degree of the ecosystem is stored. In this case, for example, content such as “creation period”, “growth period”, “maturation period”, “decline period”, or the like is recorded according to the maturation degree of the ecosystem.

In the condition column 803, a condition for satisfying a maturation degree recorded in the ecosystem maturation degree column 802 is stored for each classification of a use case recorded in the use case classification column 801.

FIG. 9 is a diagram illustrating an example of the data structure of the user role classification table 116. A record in the user role classification table 116 is set for each combination between a classification of a use case defined for the ecosystem and a user role classification. In such a manner, a policy of determining a role classification of each of users participating in the ecosystem is expressed. The user role classification table 116 illustrated in FIG. 9 has a use case classification column 901, a user role classification column 902, and a condition column 903.

In the use case classification column 901, a classification of a defined use case is stored. In this column, like in the use case classification column 801 in the ecosystem maturation degree table 115 of FIG. 8, information corresponding to that stored in the use case classification column 701 in the use case classification table 114 of FIG. 7 is stored.

In the user role classification column 902, a classification of a user role in the ecosystem is stored. In this column, according to a form of involvement of a user to service provided in the ecosystem, for example, content such as “servicer”, “consumer”, “distributor”, or the like is recorded.

In the condition column 903, a condition for satisfying a classification of a user role recorded in the user role classification column 902 is stored for each classification of a use case recorded in the use case classification column 901.

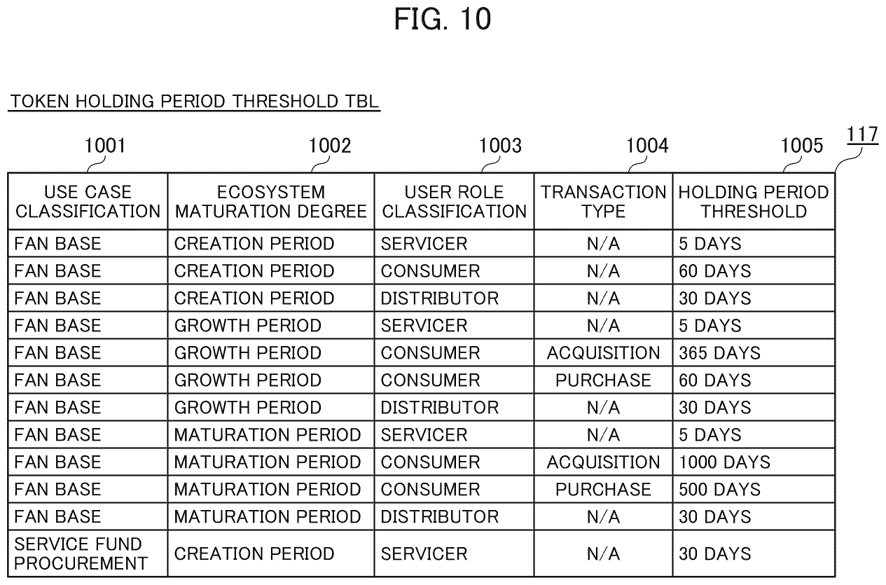

FIG. 10 is a diagram illustrating an example of the data structure of the token holding period threshold table 117. A record in the token holding period threshold table 117 is set for each combination of a classification of a use case defined for the ecosystem, a maturation degree, a user role classification, and a transaction type of a token traded in the ecosystem. Accordingly, a threshold for calculating the level of psychological loyalty from the length of a token holding period of each user is defined. The token holding period threshold table 117 illustrated in FIG. 10 has a use case classification column 1001, an ecosystem maturation degree column 1002, a user role classification column 1003, a transaction type column 1004, and a holding period threshold column 1005.

In the use case classification column 1001, a classification of a use case of the ecosystem as one of conditions of a threshold for a token holding period is stored. In this column, like in the use case classification column 801 in the ecosystem maturation degree table 115 of FIG. 8 and the use case classification column 901 in the user role classification table 116 of FIG. 9, information corresponding to that stored in the use case classification column 701 in the use case classification table 114 of FIG. 7 is stored.

In the ecosystem maturation degree column 1002, a classification of a maturation degree of the ecosystem as one of conditions of the threshold for a token holding period is stored. In this column, information corresponding to that stored in the ecosystem maturation degree column 802 in the ecosystem maturation degree table 115 of FIG. 8 is stored.

In the user role classification column 1003, a user role classification as one of conditions of the threshold for the token holding period is stored. In this column, information corresponding to that stored in the user role classification column 902 in the user role classification table 116 of FIG. 9 is stored.

In the transaction type column 1004, type of a token transaction activity as one of conditions of the threshold for the token holding period is stored. In this column, information corresponding to that stored in the transaction type column 504 in the token transaction history table 111 of FIG. 5 is stored. However, depending on a combination of the use case classification, the maturation degree, and the user role classification, there is a case that the type of a token transaction activity is not included in the conditions of the threshold for the token holding period. In this case, “n/a” expressing “not applicable” is recorded in the transaction type column 1004 of the record of the combination.

In the holding period threshold column 1005, a threshold for the token holding period is stored for each combination of the use case classification, the maturation degree, the user role classification, and the transaction type of a token traded in the ecosystem which are recorded in the use case classification column 1001, the ecosystem maturation degree column 1002, the user role classification column 1003, and the transaction type column 1004, respectively. The user loyalty calculation unit 105 calculates psychological loyalty of each user by using the threshold recorded in the holding period threshold column 1005. For example, when the token holding period exceeds the threshold, it is determined that the psychological attachment of the user to the ecosystem in which the token is used is high, and a predetermined amount of points is added to the loyalty index 113. In such a manner, the loyalty level of each user is estimated.

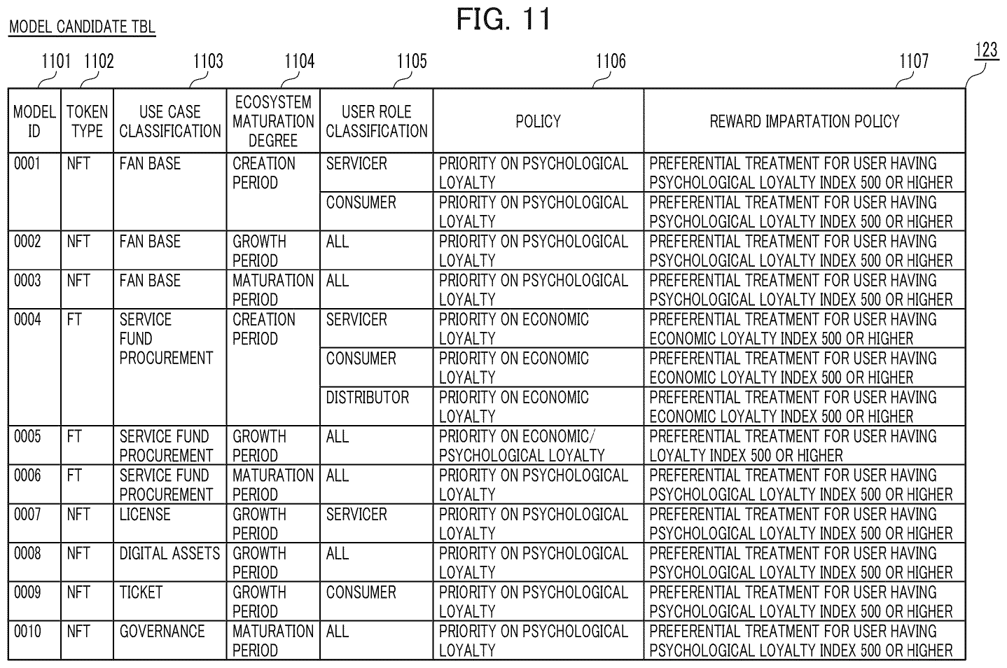

FIG. 11 is a diagram illustrating an example of the data structure of the model candidate table 123. A record in the model candidate table 123 is set for each token model applicable in the ecosystem. In such a manner, a list of token models as change candidates in the data management system of the embodiment is recorded in the model candidate table 123. The model candidate table 123 illustrated in FIG. 11 has a model ID column 1101, a token type column 1102, a use case classification column 1103, an ecosystem maturation degree column 1104, a user role classification column 1105, a policy column 1106, and a reward impartation policy column 1107. Since the content of information stored in the columns is similar to that in the columns in the token model 110 of FIG. 4, the description will not be repeated.

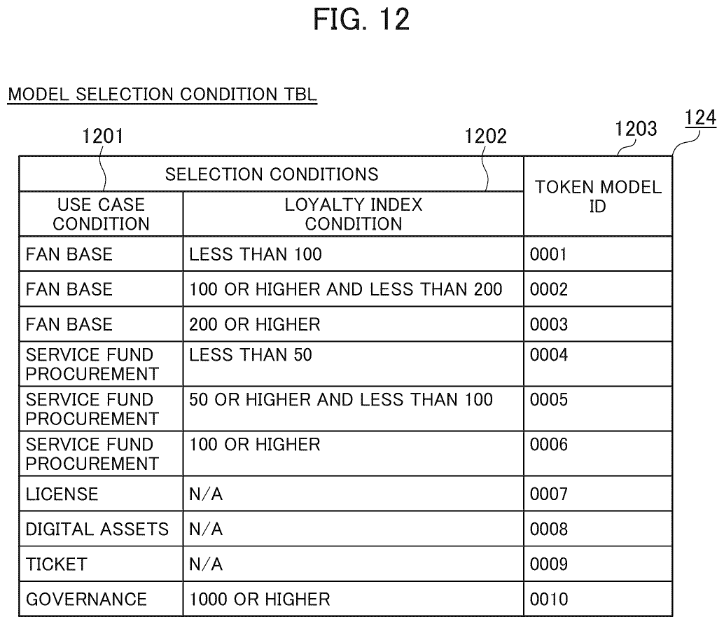

FIG. 12 is a diagram illustrating an example of the data structure of the model selection condition table 124. A record in the model selection condition table 124 is set for each condition for setting a change candidate model. In such a manner, a policy to select a change candidate model in the data management system of the embodiment is expressed. The model selection condition table 124 illustrated in FIG. 12 has a selection condition: use case condition column 1201, a selection condition: loyalty index condition column 1202, and a token model ID column 1203.

In the selection condition: use case condition column 1201, a classification of a use case of the ecosystem as one of change candidate model selection conditions is stored. In this column, like in the use case classification column 1001 in the token holding period threshold table 117 of FIG. 10, information corresponding to that stored in the use case classification column 701 in the use case classification table 114 of FIG. 7 is stored.

In the selection condition: loyalty index condition column 1202, a condition for a loyalty index as one of conditions of selecting a change candidate model is stored. In this column, the content of a condition for the loyalty index 113 calculated by using the threshold defined in the token holding period threshold table 117 of FIG. 10 is stored. Depending on the condition of a use case classification indicated in the selection condition: use case condition column 1201, there is a case where the condition of the loyalty index is not included in conditions of selecting a change candidate model. In this case, “n/a” expressing “not applicable” is recorded in the selection condition: loyalty index condition column 1202 of the record.

In the token model ID column 1203, an identifier for uniquely identifying a token model to be selected as a change candidate model is stored for each combination of conditions for a use case classification and a loyalty index recorded in the selection condition: use case condition column 1201 and the selection condition: loyalty index condition column 1202, respectively.

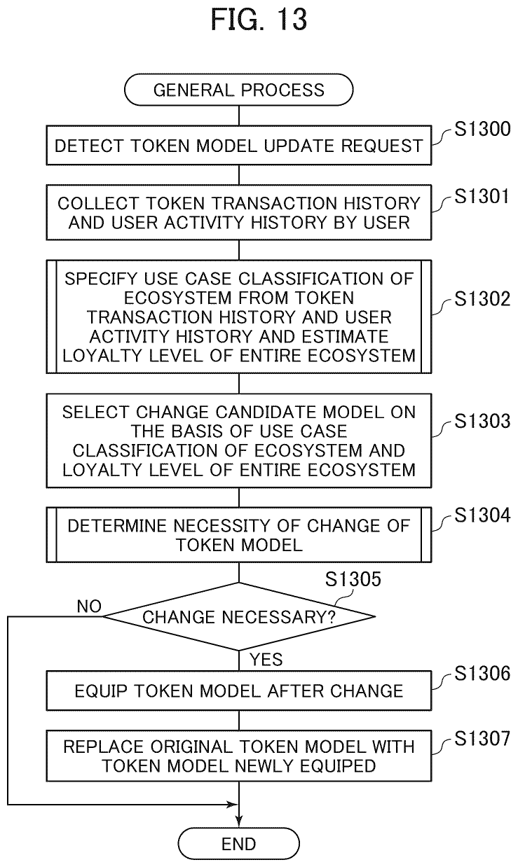

In the data management system of the embodiment, the central processing unit 202 of each user terminal 201 executes each of programs in the token application 100 and functions as the token management unit 103, the user management unit 104, and the reward determination/impartation unit 106, thereby transmitting/receiving tokens among the users, imparting tokens to the users according to a predetermined token model, and providing an ecosystem using the tokens to the users. The central processing unit 202 of each user terminal 201 executes each of programs in the token application 100 and functions as the user loyalty calculation unit 105 and the token model change unit 107, and also executes each of programs in the token management application 101 and functions as the ecosystem loyalty calculation unit 118, the token model change determination unit 119, and the token model equipment unit 120, thereby updating a token model. Hereinafter, with reference to the flowcharts of FIGS. 13 to 16, the details of processes executed at the time of updating a token model in the data management system of the embodiment will be described.

FIG. 13 is a flowchart illustrating the flow of entire process of the data management system at the time of updating a token model.

First, the token model change determination unit 119 detects a token model update request which is output from any of the user terminals 201 (step S1300).

Subsequently, the token model change determination unit 119 collects a token transaction history and a user activity history by user via the token management unit 103 and the user management unit 104 (step S1301). The token transaction history of each user recorded in the token transaction history table 111 is collected via the token management unit 103, and the user activity history other than a token transaction in which the psychological state of the user related to the token in the activity histories in the ecosystem of each user recorded in the user activity history table 112 is reflected is collected via the user management unit 104.

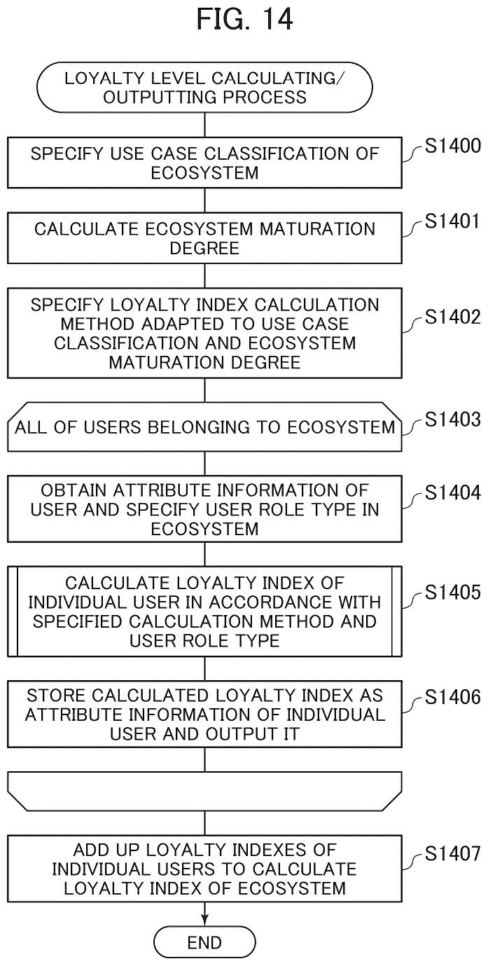

Subsequently, the ecosystem loyalty calculation unit 118 specifies the use case classification in the ecosystem from the token transaction history and the user activity history collected by the token model change determination unit 119 in step S1301 and estimates the loyalty level in the entire ecosystem (step S1302). The details of processes executed in the step will be described later with reference to FIG. 14.

The token model change determination unit 119 selects a token model adapted to the state of the ecosystem at present as a change candidate model on the basis of the use case classification and the loyalty level of the ecosystem specified or estimated by the ecosystem loyalty calculation unit 118 in step S1302 (step S1303). In this case, referring to the model selection condition table 124 of FIG. 12, a record in which the content of the selection condition: use case condition column 1201 matches a use case classification of the ecosystem and the condition described in the selection condition: loyalty index condition column 1202 is satisfied by the loyalty level of the ecosystem is specified. In such a manner, a token model corresponding to the identifier written in the token model ID column 1203 of the record can be selected as a change candidate model.

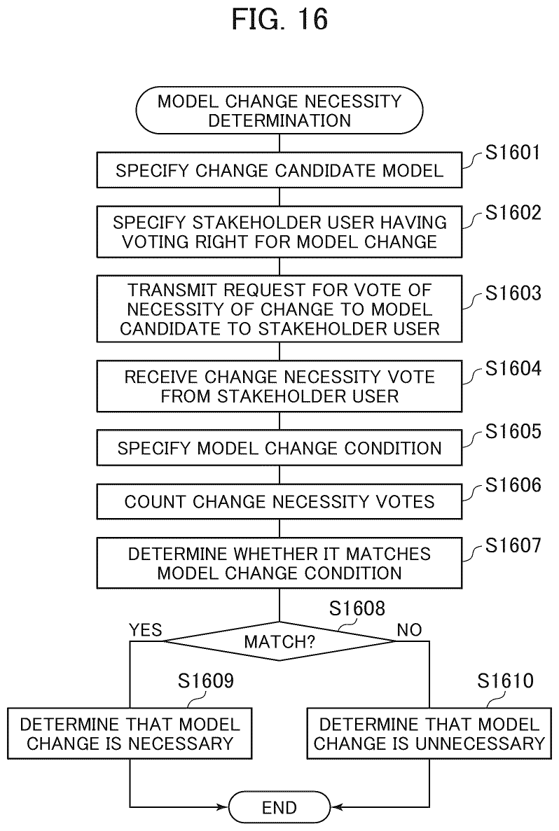

Further, the token model change determination unit 119 determines necessity of a change of a token model from the present token model to the change candidate model selected in step S1303 (step S1304). The details of the process executed in the step will be explained with reference to FIG. 16 which will be described later.

Subsequently, the token model change determination unit 119 determines a determination result for the necessity of a change of the token model obtained by the process of the step S1304, which is “change necessary” or “change unnecessary” (step S1305). In the case where it is determined in step S1304 that a change of the token model is necessary (step S1305: YES), the process is advanced to the next step S1306. In the case where it is determined in step S1305 that a change of the token model is unnecessary (step S1305: NO), the processes illustrated in the flowchart of FIG. 13 are finished.

In the case where the program advances to step S1306, the token model equipment unit 120 equips each user terminal 201 with the change candidate model selected by the token model change determination unit 119 in step S1303 as a token model after the change (step S1306).

When the token model after the change is equipped in step S1306, the token model change unit 107 in each user terminal 201 replaces the original token model with the newly equipped token model (step S1307). At this time, the token model change determination unit 119 sends a token model replacement control instruction to the token model change unit 107 of each user terminal 201. When the control instruction is received, the token model change unit 107 rewrites the token model 110 according to the content of the token model after the change to replace the token model.

After the process of step S1307 is executed, the processes illustrated in the flowchart of FIG. 13 are finished. After that, according to the token model after the change, a reward is imparted to each user by the reward determination/impartation unit 106.

In the data management system of the embodiment, by executing update of a token model in accordance with the flowchart of FIG. 13, the loyalty level of users in the entire ecosystem forming the token economy is estimated, and the ecosystem can be analyzed. By selecting a token model adapted to the state of the ecosystem from the result of estimation of the loyalty level and replacing to the token model to the selected token model, design and operation of incentive to each user can be flexibly changed according to the activity and the psychological state of the user layer in the ecosystem.

FIG. 14 is a flowchart illustrating the flow of loyalty level calculating/outputting process executed in step S1302 in FIG. 13.

First, according to an instruction from the ecosystem loyalty calculation unit 118, the user loyalty calculation unit 105 specifies a use case classification of the ecosystem (step S1400). For example, in the token application 100 executed by the central processing unit 202 in any user terminal 201, the user loyalty calculation unit 105 refers to the token transaction history table 111 and the user activity history table 112 via the token management unit 103 and the user management unit 104, and collects a token transaction history and a user activity history of each user. By determining any of conditions specified in the condition column 702 in the use case classification table 114, which is satisfied on the basis of the history information collected, the use case classification in the ecosystem can be specified. Alternatively, a use case classification in an ecosystem as a loyalty level estimation object may be specified from use case classifications preliminarily designated for each ecosystem.

Subsequently, the user loyalty calculation unit 105 calculates the maturation degree of the ecosystem (step S1401). In this case, the maturation degree of the ecosystem can be calculated by determining a condition designated in the condition column 803 which is satisfied among the matched use case classifications specified in the use case classification column 801 in the ecosystem maturation degree table 115 on the basis of the use case classification in the ecosystem specified in step S1400 and the token transaction history and the user activity history of each user collected at that time.

Subsequently, the user loyalty calculation unit 105 specifies a method of calculating a loyalty index adapted to the use case classification of the ecosystem specified in the step S1400 and the maturation degree of the ecosystem calculated in step S1401 (step S1402). For example, any of a plurality of kinds of calculating methods which are preliminarily set can be specified according to a combination of the use case classification and the maturation degree of the ecosystem. Alternatively, regardless of the combination between the use case classification and the maturation degree of the ecosystem, the loyalty index calculating method may be fixed.

The user loyalty calculation unit 105 executes the loop process from the subsequent step S1404 to step S1406 for all of the users belonging to the ecosystem (step S1403). By sequentially selecting the users and executing each of the processes from step S1404 to step S1406, the loyalty index as an index expressing the psychological attachment degree of each user to the ecosystem is calculated.

In the loop process, first, the user loyalty calculation unit 105 obtains the attribute information of the user which is preliminarily set for the user being selected and specifies a role classification of the user in the ecosystem (step S1404). In this case, any of role classifications such as a servicer providing service to another user in the ecosystem, a consumer using service provided by a servicer, and a distributor intermediating service between a servicer and a consumer can be specified as the role classification of the user being selected.

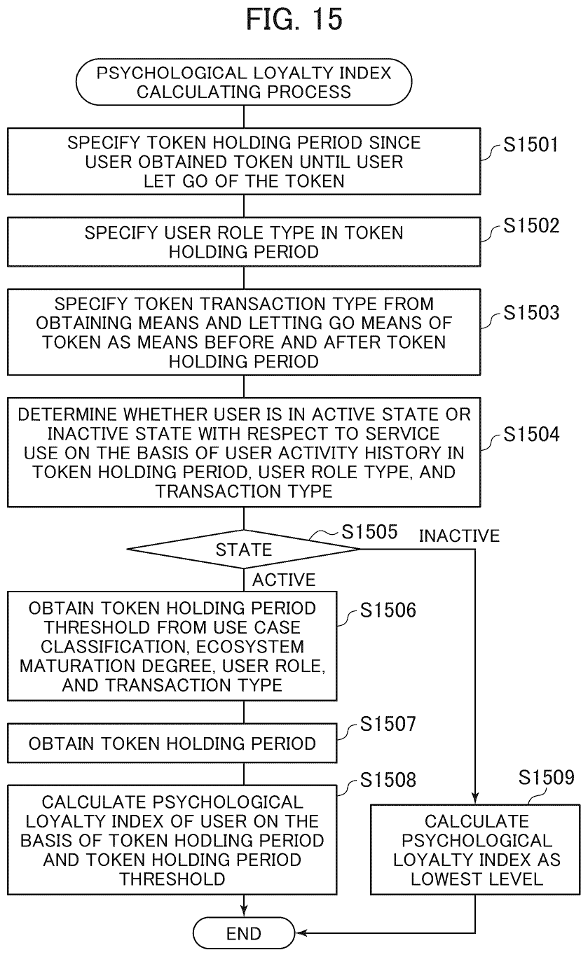

Next, the user loyalty calculation unit 105 calculates an individual user loyalty index for the ecosystem of the user being selected on the basis of the method of calculating the loyalty index specified in step S1402 and the role type of the user specified in step S1404 (step S1405). The process details of the step will be explained with reference to FIG. 15 which will be described later.

After that, the user loyalty calculation unit 105 stores the loyalty index calculated in step S1405 as a part of the attribute information of an individual user for the user being selected and outputs it to the ecosystem loyalty calculation unit 118 (step S1406). At this time, the calculated loyalty index may be also presented to the user by outputting it on the screen of a display device included in the external input/output device 205 in the user terminal 201 held by the user being selected. In such a manner, the result of calculation of the loyalty index of the user himself/herself can be notified to the user.

After completion of the loop process from step S1404 to step S1406, finally, the ecosystem loyalty calculation unit 118 adds up the loyalty indexes of the users calculated by the user loyalty calculation unit 105 in the loop process to calculate the loyalty index of the entire ecosystem (step S1407). By outputting the calculated loyalty index to each of the user terminals 201 and outputting it on the screen of the display device included in the external input/output device 205 in each of the user terminals 201, the loyalty index is presented to the user. After execution of the process of step S1407, the processes illustrated in the flowchart of FIG. 14 are finished, and the program advances to step S1303 in FIG. 13.

By executing the process flow, the level of loyalty to the ecosystem of an individual user can be measured, and incentive design according to the level of loyalty of an individual user can be made. The level of loyalty of the entire ecosystem determined from the levels of loyalty of all of users constructing the ecosystem can be also measured, and incentive design and selection of a token model according to the level of loyalty can be performed. Further, since the use case classification of the ecosystem can be specified from the token transaction history and the user activity history and the maturation degree of the ecosystem can be analogized, the level of loyalty of the user and the level of the user loyalty in the entire ecosystem can be measured on the basis of those results.

FIG. 15 is a flowchart illustrating the flow of the psychological loyalty index calculating process executed in step S1405 in FIG. 14.

First, the user loyalty calculation unit 105 refers to the token transaction history table 111 via the token management unit 103 and specifies a token holding period since the user obtains a token until the user lets the token go (step S1501).

Next, the user loyalty calculation unit 105 specifies a role classification of the user in the token holding period specified in step S1501 (step S1502). By obtaining the process result of the above-described step S1404, the role classification of the user in the token holding period can be specified.

Subsequently, the user loyalty calculation unit 105 specifies the transaction type of the token (step S1503). For example, by specifying means of obtaining a token at the beginning of the token holding period specified in step S1501 and means of letting the token go at the end of the token holding period with reference to the transaction content in the token transaction history table 111, the token transaction type can be specified from the content. The specified token transaction type is recorded in the transaction type column 504 in the token transaction history table 111.

Further, the user loyalty calculation unit 105 specifies the user activity history in the token holding period specified in step S1501 by referring to the user activity history table 112 via the user management unit 104, and specifies the activity content of the user in the token holding period from the user activity history. From the specified user activity content and the user role classification and the token transaction type specified in steps S1502 and S1503, respectively, it is determined that the user is in either the active state or the inactive state with respect to the service use (step S1504).

In step S1504, for example, in the case where any user activity history in the token holding period is recorded, it is determined that the user is in the active state. When nothing is recorded, it is determined that the user is in the inactive state. Even when the user activity history is recorded, in the case where the token transaction type is “forced exchange”, it is determined that the user is in the inactive state. Even when the user activity history is not recorded, in the case where the user role classification is “servicer” or “distributor”, it is determined that the user is in the active state. Other than the above, it can be determined that the user is in either the active state or the inactive state by an arbitrary method.

After that, the user loyalty calculation unit 105 determines a process step to which the program advances next according to the determination result of step S1504 (step S1505). When it is determined in step S1504 that the user is in the active state, the program advances to step S1506. When it is determined that the user is in the inactive state, the program advances to step S1509.

In step S1506, the user loyalty calculation unit 105 obtains the token holding period threshold to be compared with the token holding period specified in step S1501. In this case, the use case classification and the maturation degree of the ecosystem specified in steps S1400 and S1401, respectively, and the user role classification and the token transaction type specified in steps S1502 and S1503, respectively, are obtained. On the basis of the information obtained, the relevant record is retrieved in the token holding period threshold table 117 and the value of the holding period threshold column 1005 of the record is referred to, thereby enabling the token holding period threshold to be obtained.

Subsequently, the user loyalty calculation unit 105 obtains the token holding period specified in step S1501 (step S1507).

Finally, the user loyalty calculation unit 105 calculates the psychological loyalty index of the user on the basis of the token holding period obtained in step S1507 and the token holding period threshold obtained in step S1506 (step S1508). In this case, the token holding period and the token holding period threshold are compared. When the token holding period is equal to or larger than the token holding period threshold, a predetermined addition value is added to the loyalty index of the user according to the loyalty index calculating method specified in the above-described step S1402. The addition value to the loyalty index may be changed according to the magnitude of the difference between the token holding period and the token holding period threshold. On the other hand, when the token holding period is less than the token holding period threshold, without addition to the loyalty index of the user, a predetermined initial value is set as the loyalty index of the user. In such a manner, based on the result of comparison between the token holding period and the token holding period threshold, the loyalty index of the user who is in the active state can be calculated.

On the other hand, in step S1509, the user loyalty calculation unit 105 calculates the psychological loyalty index of the user as the value of the lowest level. Preferably, the loyalty index calculated here is a value lower than the initial value which is set in the case where the token holding period is less than the token holding period threshold in step S1508. Consequently, with respect to the user who is in the inactive state, regardless of the token holding period, the loyalty index can be calculated as a value lower than that of the user who is in the active state.

After calculating the loyalty index of the user in step S1508 or S1509, the user loyalty calculation unit 105 finishes the processes illustrated in the flowchart of FIG. 15, and advances to the step S1406 in FIG. 14.

By executing the process flow, the level of the psychological loyalty of the user to the ecosystem can be estimated. On assumption that the user having the token for a long period has psychological attachment or feeling of support to the ecosystem and feels empathy for the vision of the ecosystem, it can be analogized that the level of loyalty is high. On the other hand, it can be analogized that the user who obtains a token and quickly exchanges it to legal currency having more general versatility or the like has high economic loyalty to the ecosystem and low psychological loyalty to the ecosystem. Based on those hypotheses, from the activity history of a user accompanying no transaction of a token in an ecosystem, the loyalty index of the user can be calculated as an index expressing psychological attachment to the ecosystem of the user.

FIG. 16 is a flowchart illustrating the flow of model change necessity determining process executed in step S1304 in FIG. 13.

First, the token model change determination unit 119 specifies a change candidate model (step S1601). In this step, a change candidate model can be specified from the process result of the above-described step S1303.

Subsequently, the token model change determination unit 119 specifies a user having a voting right for a model change as a stakeholder user (step S1602). For example, by determining the presence/absence of the voting right with respect to a user from the attribute information of the user which is preliminarily set, a stakeholder user can be specified.

Then, the token model change determination unit 119 transmits a voting request for questioning the necessity of a token model change from a present token model to a change candidate model to each of stakeholder users specified in step S1602 (step S1603). The voting request is transmitted to the user terminal 201 which each of the stakeholder users has by the communication interface 206.

The token model change determination unit 119 receives a voting result from each of the stakeholder users to the voting request transmitted in step S1603 (step S1604).

Further, the token model change determination unit 119 specifies a model change condition for determining whether the token model is changed or not in accordance with the voting result (step S1605). For example, by specifying a model change condition corresponding to the ecosystem of which the loyalty index is calculated in the above-described step S1407 among the model change conditions which are preliminarily set for each ecosystem, the process of step S1605 can be performed.

The token model change determination unit 119 adds up voting results on whether the token model is to be changed or not received from stakeholder users in step S1604 (step S1606). At this time, it is also possible to set a predetermined totaling period and make only voting results received in the totaling period effective.

The token model change determination unit 119 determines whether or not the totaling result in step S1606 matches the model change condition specified in step S1605 (step 1607), and determines the next process step in accordance with the determination result (step S1608). When it is determined in step S1607 that the result matches the model change condition, the program advances to step S1609. When it is determined that the result does not match the model change condition, the program advances to step S1610.

In step S1609, the token model change determination unit 119 sends back the determination result that the model change is necessary, and the processes illustrated in the flowchart of FIG. 15 are finished.

In step S1610, the token model change determination unit 119 sends back the determination result that the model change is unnecessary, and the processes illustrated in the flowchart of FIG. 15 are finished.

By executing the process flow, users including a provider (servicer) providing service in the ecosystem and a service user (consumer) using the service provided can consensually determine whether a change of the token model is necessary or not. In such a manner, a token model which is highly satisfactory and convincing for service users can be employed. By distributing the voting right preferentially to a user having a high loyalty index to an ecosystem, the voices of users having high loyalty to the ecosystem are easily reflected in incentive design of the ecosystem, and a more effective user experience and a service success can be realized.

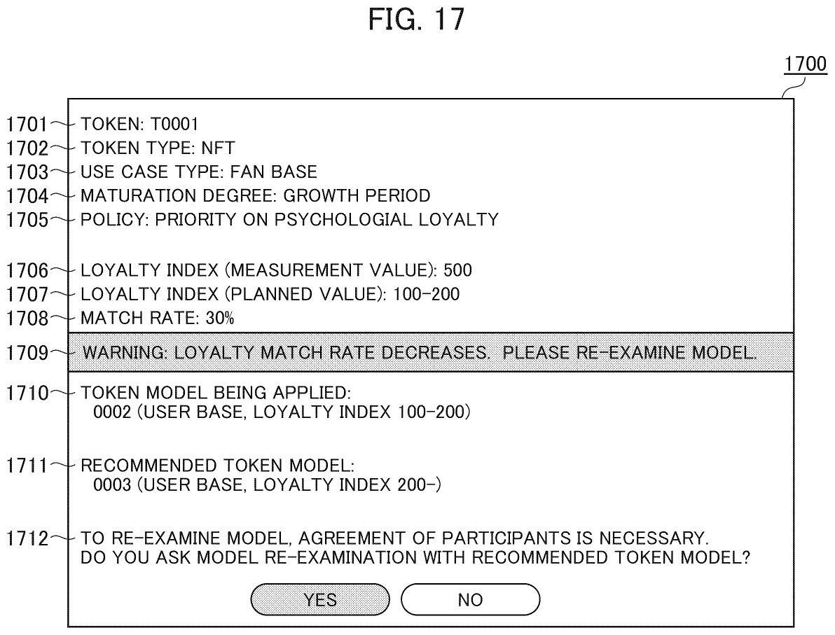

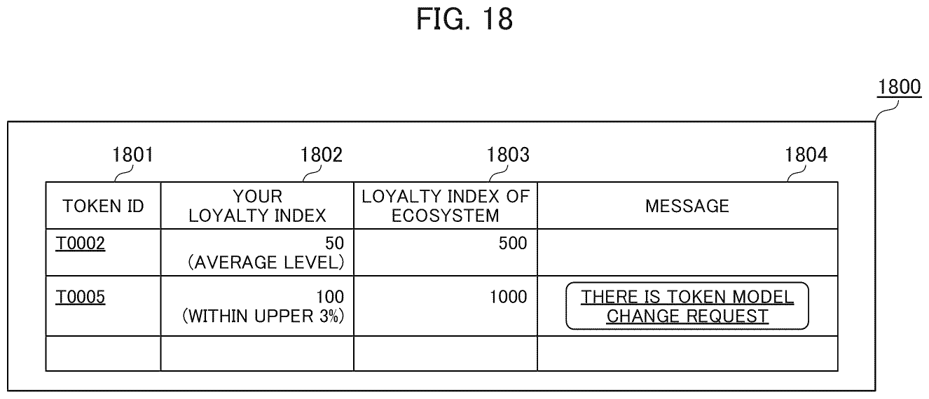

Subsequently, an example of the screen displayed in the user terminal 201 will be described with reference to FIGS. 17 and 18.

FIG. 17 is a diagram illustrating an example of an administration screen 1700 displayed in the user terminal 201 held by the administrator of the ecosystem. The administration screen 1700 illustrated in FIG. 17 has a token ID field 1701, a token type field 1702, a use case type field 1703, an ecosystem maturation degree field 1704, a loyalty priority policy field 1705, a loyalty index (measurement value) field 1706, a loyalty index (planned value) field 1707, a match rate field 1708, a message field 1709, an applied token model field 1710, a recommended token model field 1711, and a token re-examination request field 1712.

In the token ID field 1701, identification information for uniquely identifying a token which is presently displayed on the administration screen 1700 is displayed. In this field, the identification information of the relevant token is displayed on the basis of the ID column 301 in the token table 109.

In the token type field 1702, the token type of the token written in the token ID field 1701 is indicated. In this field, the type of the relevant token is indicated on the basis of the token type column 302 in the token table 109.

In the use case type field 1703, the use case type of the ecosystem in which the token written in the token ID field 1701 is used is indicated. In this field, the use case classification of the ecosystem specified in the step S1400 in FIG. 14 is indicated.

In the ecosystem maturation degree field 1704, the ecosystem maturation degree corresponding to the token written in the token ID field 1701 is indicated. In this field, the maturation degree of the ecosystem calculated in step S1401 in FIG. 14 is indicated.

In the loyalty priority policy field 1705, the loyalty priority policy of the token model 110 applied to the token written in the token ID field 1701 is indicated. In this field, on the basis of the policy column 406 in the token model 110, the content of the priority policy of the loyalty in the token model being applied is indicated.

In the loyalty index (measurement value) field 1706, the present measurement value of the loyalty index of the entire ecosystem related to the token indicated in the token ID field 1701 is indicated. In this field, the loyalty index in the entire ecosystem calculated in step S1407 in FIG. 14 is indicated.

In the loyalty index (planned value) field 1707, the loyalty index of the entire ecosystem assumed by the token model applied to the token indicated in the token ID field 1701 is written. In this field, a target value of a loyalty index which is preliminarily set is indicated.

In the match rate field 1708, the rate of the loyalty index indicated in the loyalty index (measurement value) field 1706 for the loyalty index indicated in the loyalty index (planned value) field 1707 is written. It expresses the degree of match of the token model being currently applied with the level of loyalty of an ecosystem assumed on the basis of the level of loyalty of the present ecosystem.

In the message field 1709, a message to the administrator is written. In this field, advice for an action to be taken by the administrator or the like is written on the basis of the rate of the loyalty index indicated in the match rate field 1708.

In the applied token model field 1710, a token model being currently applied is indicated. In this field, information regarding the token model being applied is indicated on the basis of the token model 110.

In the recommended token model field 1711, a recommended token model to which the present token model is recommended to be changed is indicated. In this field, information of the change candidate model selected in step S1303 in FIG. 13 is indicated.

In the token re-examination request field 1712, in the case where agreement of stakeholders is necessary to change a token model, transmission buttons for transmitting a request asking whether a change is necessary or not to a related stakeholder are indicated. By selecting one of the transmission buttons on the administration screen 1700, in step S1603 in FIG. 16, the administrator can transmit a voting request for asking necessity of a token model change from the present token model to the change candidate model to each of stakeholder users.

FIG. 18 is a diagram illustrating an example of a user screen 1800 displayed in the user terminal 201 held by each of users participating in the ecosystem. The user screen 1800 illustrated in FIG. 18 has a token ID column 1801, a “your loyalty index” column 1802, an ecosystem loyalty index column 1803, and a message column 1804.

In the token ID column 1801, an identifier uniquely identifying a token held by the user is indicated. In this column, based on the user ID column 502 and the token ID column 503 in the token transaction history table 111, the identification information of the token currently held by the user is indicated.

In the “your loyalty index” column 1802, the present value of the loyalty index of the user related to the token indicated in the token ID column 1801 is written. In this column, the loyalty index of the user calculated in step S1405 in FIG. 14 is indicated. As illustrated in FIG. 18, rank information indicating ranking in the entire ecosystem of the user on the basis of the value of the loyalty index or the like may be indicated together with the loyalty index of the user. Although only the present value of the loyalty index of the user is indicated in FIG. 18, a history of the previous loyalty index of the user may be also indicated by a table, a chart, or the like.

In the ecosystem loyalty index column 1803, the loyalty index in the entire ecosystem related to the token indicated in the token ID column 1801 is indicated. In this column, the loyalty index of the ecosystem calculated in step S1407 in FIG. 14 is indicated. Although only the present value of the loyalty index of the ecosystem is indicated in FIG. 18, a history of the previous loyalty index of the entire ecosystem may be indicated by a table, a chart, or the like.

In the message column 1804, a message to the user is indicated. For example, in the case where a message asking necessity of a change of a token model with respect to a certain token is received, a message expressing it is indicated as illustrated in FIG. 18.

The above-described embodiment of the present invention produces the following effects.
(1) The data management system for analyzing an ecosystem in which a plurality of users participate and services are provided via tokens among the users, by the process of the central processing unit 202, obtains a token transaction history expressing a token transaction history of each of the users and a user activity history expressing an activity history in the ecosystem of each of the users (step S1301). Based on the token transaction history and the user activity history obtained, the loyalty index expressing the loyalty level of the user to the ecosystem is calculated (step S1405). By adding up loyalty indexes of a plurality of users participating in the ecosystem, the loyalty level in the entire ecosystem is estimated (step S1407). In such a manner, analysis of an ecosystem can be performed properly.
(2) The user activity history obtained in step S1301 includes a user activity history which does not accompany a transaction of a token in an ecosystem. The loyalty index calculated in step S1405 is an index expressing psychological attachment to an ecosystem of a user. In such a manner, the loyalty of a user which is not reflected in economic contribution degree can be properly estimated.
(3) The user loyalty calculation unit 105 specifies a token holding period of a user on the basis of a token transaction history (step S1501), and specifies the user activity content in the ecosystem in the token holding period on the basis of the user activity history (step S1504). In such a manner, the loyalty index according to the psychological loyalty level of the user can be properly calculated in consideration of the user activity content in the token holding period.
(4) The user loyalty calculation unit 105 determines the state of the user which is either an active state or an inactive state on the basis of the specified user activity content (step S1504). As a result, when it is determined that the user is in the active state, the loyalty index is calculated on the basis of a token holding period (step S1508). When it is determined that the user is in the inactive state, the loyalty index is calculated as a value lower than that in the case where it is determined that the user is in the active state (step S1509). In such a manner, regardless of the token holding period, the loyalty index of the user can be calculated as a proper value according to the state of the user.
(5) The user loyalty calculation unit 105 calculates the loyalty index on the basis of a result of comparison of the token holding period with a predetermined threshold (step S1508). In such a manner, for a user in the active state, the loyalty index of the user can be calculated by a proper value in consideration of the token holding period.
(6) The user loyalty calculation unit 105 specifies a use case classification of the ecosystem (step S1400). The user loyalty calculation unit 105 calculates the maturation degree of an ecosystem on the basis of token transaction histories and user activity histories of a plurality of users participating in the ecosystem (step S1401). Further, the user loyalty calculation unit 105 specifies the user role classification in the token holding period (step S1502). In addition, the user loyalty calculation unit 105 specifies the token transaction type by the user on the basis of the token transaction history (step S1503). Based on the information specified or calculated, a threshold to be compared with a token holding period is determined (step S1506). In such a manner, a threshold to be compared with a token holding period can be properly set in accordance with an ecosystem and the state of a user.
(7) The token model change determination unit 119 determines a token model for determining a token operation condition as a change candidate model on the basis of a loyalty level in an entire ecosystem (step S1303). In such a manner, a token model adapted to the state of an ecosystem at present can be determined as a change candidate model as a candidate of a token model after a change.
(8) The ecosystem loyalty calculation unit 118 specifies a use case classification in an ecosystem (step S1302). The token model change determination unit 119 determines a change candidate model on the basis of the specified use case classification in the ecosystem and the estimated loyalty level of the ecosystem (step S1303). In such a manner, a change candidate model can be determined in consideration with the loyalty level in the entire ecosystem and, in addition, the use case classification of the ecosystem.
(9) The token model change determination unit 119 notifies the token model determined as the change candidate model to each of users having a voting right among a plurality of users participating in the ecosystem (step S1603). Based on a voting result from users each having the voting right, whether the change candidate model is applied to the ecosystem or not is determined (steps S1606 to S1610). In such a manner, while reflecting feelings of various users participating in the ecosystem, a token model which is satisfactory for each of users can be applied.

The present invention is not limited to the foregoing embodiment and can be executed by using arbitrary components without departing from the gist.

The above-described embodiment and modifications are just an example. Unless otherwise the characteristics of the invention are not impaired, the present invention is not limited to the above. Although various embodiments and modifications have been described above, the present invention is not limited to the above. The other modes which are considered within the scope of the technical ideas of the present invention also lie in the scope of the present invention.

### LIST OF REFERENCE SIGNS

100, 100a, 100b, 100c . . . token application
101, 101a, 101b, 101c . . . token management application
102 . . . blockchain network
103 . . . token management unit
104 . . . user management unit
105 . . . user loyalty calculation unit
106 . . . reward determination/impartation unit
107 . . . token model change unit
108 . . . storage unit
109 . . . token table
110 . . . token model
111 . . . token transaction history table
112 . . . user activity history table
113 . . . loyalty index
114 . . . use case classification table
115 . . . ecosystem maturation degree table
116 . . . user role classification table
117 . . . token holding period threshold table
118 . . . ecosystem loyalty calculation unit
119 . . . token model change determination unit
120 . . . token model equipment unit
121 . . . storage unit
122 . . . ecosystem loyalty index
123 . . . model candidate table
124 . . . model selection condition table
201, 201a, 201b, 201c . . . user terminal
202 . . . central processing unit
203 . . . main storage device
204 . . . external storage device
205 . . . external input/output device
206 . . . communication interface
207 . . . bus
208 . . . network

1. An ecosystem analysis method in which a plurality of users participates and service is provided among the users via a token, comprising:
obtaining a token transaction history expressing a transaction history of the token of the user and a user activity history expressing an activity history in the ecosystem of the user by a computer;
calculating a loyalty index expressing a loyalty level of the user for the ecosystem on the basis of the token transaction history and the user activity history by the computer; and
estimating loyalty level in the entire ecosystem by adding up the loyalty indexes of the plurality of users participating in the ecosystem.

2. An ecosystem analysis method according to claim 1,
wherein the user activity history includes an activity history of the user, which does not accompany a transaction of the token in the ecosystem, and
the loyalty index is an index expressing the degree of psychological attachment to the ecosystem of the user.

3. The ecosystem analysis method according to claim 2,
wherein the token holding period of the user is specified on the basis of the token transaction history,
the user activity content in the token holding period in the ecosystem is specified on the basis of the user activity history, and
the loyalty index is calculated on the basis of the user activity content.

4. The ecosystem analysis method according to claim 3,
wherein it is determined that the user is in an active state or an inactive state on the basis of the user activity content,
when it is determined that the user is in the active state, the loyalty index is calculated on the basis of the token holding period, and
when it is determined that the user is in the inactive state, the loyalty index is calculated as a value lower than that in the case where it is determined that the user is in the active state.

5. The ecosystem analysis method according to claim 4,
wherein the loyalty index is calculated on the basis of a result of comparison of the token holding period with a predetermined threshold.

6. The ecosystem analysis method according to claim 5,
wherein a use case classification of the ecosystem is specified, and
the threshold is determined on the basis of the use case classification.

7. The ecosystem analysis method according to claim 5,
wherein a maturation degree of the ecosystem is calculated on the basis of the token transaction histories and the user activity histories of a plurality of users participating in the ecosystem, and
the threshold is determined on the basis of the maturation degree.

8. The ecosystem analysis method according to claim 5,
wherein a role classification of the user in the token holding period is specified, and
the threshold is determined on the basis of the role classification.

9. The ecosystem analysis method according to claim 5,
wherein a transaction type of the token by the user is specified on the basis of the token transaction history, and
the threshold is determined on the basis of the transaction type.

10. The ecosystem analysis method according to claim 1,
wherein a token model for determining an operation condition of the token is determined on the basis of loyalty level of the entire ecosystem.

11. The ecosystem analysis method according to claim 10,
wherein the use case classification in the ecosystem is specified, and
the token model is determined on the basis of the use case classification and the loyalty level of the ecosystem.

12. The ecosystem analysis method according to claim 10,
wherein the determined token model is notified to each of users having voting right among the plurality of the users participating in the ecosystem, and
on the basis of a result of the voting from the users having the voting right, whether the determined token model is applied to the ecosystem or not is determined.

13. A system for analyzing an ecosystem in which a plurality of users participates and service is provided via a token among the users, comprising:
a storage unit storing a token transaction history table in which a token transaction history of each user is recorded, and a user activity history table in which an activity history in the ecosystem of each user is recorded;
a user loyalty calculation unit calculating a loyalty index expressing loyalty level of each of users for the ecosystem on the basis of the token transaction history table and the user activity history table; and
an ecosystem loyalty calculation unit estimating loyalty level of the entire ecosystem by adding up the loyalty indexes of the plurality of the users participating in the ecosystem calculated by the user loyalty calculation unit.
